(19) United States
(12) Patent Application Publication
(10) Pub. No.: US 2013/0024366 A1
(43) Pub. Date: Jan. 24, 2013

(54) MERCHANT INITIATED PAYMENT USING CONSUMER DEVICE

(71) Applicants: Partha Sarathi Mukherjee, San Jose, CA (US); Ji Zhang, Sunnyvale, CA (US)

(72) Inventors: Partha Sarathi Mukherjee, San Jose, CA (US); Ji Zhang, Sunnyvale, CA (US)

(73) Assignee: eBay, Inc., San Jose, CA (US)

(21) Appl. No.: 13/187,836

(22) Filed: Jul. 21, 2011

(51) Int. Cl. G06Q 40/00

(52) U.S. Cl. 705/40

(57) ABSTRACT

A merchant initiates a payment process by sending transaction details, merchant information, and a user or customer phone number to a payment service provider. The payment service provider sends a message to the user device, either asking the user to confirm the payment or communicating an authorization code. In the former, the user may be asked to simply confirm or communicate a user code. In the latter, the user communicates the authorization code to the merchant, who then communicates it to the payment servicer provider. In either case, once received and approved, the payment service provider sends a confirmation message to the merchant and the user that the payment has been approved and processed. Communication can be by text or verbal.

### BACKGROUND

1. Field of the Invention

The present invention generally relates to mobile payments.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an online or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why online or mobile purchases are growing very quickly.

One limitation to online or mobile purchasing is that the user typically needs a smart phone to access the Internet. Even though smart phones are becoming more widely available and used, there are still many users who do not have smart phones. As a result, these user may not be able to user the services of a payment service provider through a cell phone or other non-smart phone. This results in lost sales for the merchant and users.

Thus, there is a need for a payment process that allows users without smart phones to make payments through the user device.

### SUMMARY

According to one embodiment, a merchant initiates a payment process by sending transaction details, merchant information, and a user or customer phone number to a payment service provider. The payment service provider access a user account with the payment service provider based on the user phone number, e.g., the user's cell phone number, and processes the payment request from the merchant. If the payment request can be approved, the payment service provider sends a text message, such as via SMS, to the user's phone, asking the user to confirm or cancel the transaction. The message may include buttons, links, or instructions on how to confirm or cancel. The user can confirm the transaction, such as by sending a text message back to the payment service provider. In one embodiment, the user may be required to enter a PIN or password. Once received, the payment service provider sends a confirmation message to the merchant and the user that the payment has been approved and processed.

In another embodiment, a merchant initiates a payment process by sending transaction details, merchant information, and a user or customer phone number to a payment service provider. The payment service provider access a user account with the payment service provider based on the user phone number, e.g., the user's cell phone number, and processes the payment request from the merchant. If the payment request can be approved, the payment service provider calls the user on the user's cell phone and provides a voice message of the payment details, which may include amount, merchant name, and other information. The voice message may also include instructions on how to approve or cancel the transaction, such as speaking or entering a user code/PIN to approve or to say “No” or press a button on the user's device to cancel. Once received (and assuming the code is proper), the payment service provider communicates to the merchant and the user that the payment has been approved and processed. The user may be informed by another voice message, text, or other means.

In yet another embodiment, a merchant initiates a payment process by sending transaction details, merchant information, and a user or customer phone number to a payment service provider. The payment service provider access a user account with the payment service provider based on the user phone number, e.g., the user's cell phone number, and processes the payment request from the merchant. If the payment request can be approved, the payment service provider sends a text message, such as via SMS, to the user's phone, that includes an authorization number. If the user decides to proceed with the purchase, the user communicates the authorization number to the merchant, such as by showing the displayed number, entering it into a merchant device, having the number scanned by the merchant, or dictating the number to the merchant. In one embodiment, the user may be required to enter a PIN or password and transmit that back to the payment service provider. The merchant may then send a response to the payment service provider, which may include the authorization number. After receipt, the payment service provider may process the information, such as determining whether the authorization number is valid and associated with the proper merchant, transaction, and/or user. If approved, the merchant and/or user may receive a confirmation message from the payment service provider that the payment has been approved and processed.

As a result, a user can make a payment at a point of sale (POS) of a merchant using the user's mobile device without the mobile device having to be a smart phone. This allows the user to obtain advantages of the payment service provider.

These and other features and advantages of the present disclosure will be more readily apparent from the detailed description of the embodiments set forth below taken in conjunction with the accompanying figures.

### BRIEF DESCRIPTION OF THE FIGURES

FIG. 1 is a flow chart illustrating an embodiment of a method for a merchant-initiated payment process through a user device where the user receives a text message to confirm the payment;

FIG. 2 is a flow chart illustrating an embodiment of a method for a merchant-initiated payment process through a user device where the user receives a voice message and enters a code to confirm the payment;

FIG. 3 is a flow chart illustrating an embodiment of a method for a merchant-initiated payment process through a user device where the user receives a code to present to the merchant;

FIG. 4 is a schematic view illustrating an embodiment of a networked system that can be used to perform the methods of FIGS. 1-3;

FIG. 5 is a perspective view illustrating an embodiment of a user device that can be used to make a payment according to the methods of FIGS. 1-3; and

FIG. 6 is a schematic view illustrating an embodiment of a computer system that can be used to implement one or more devices in FIG. 4.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

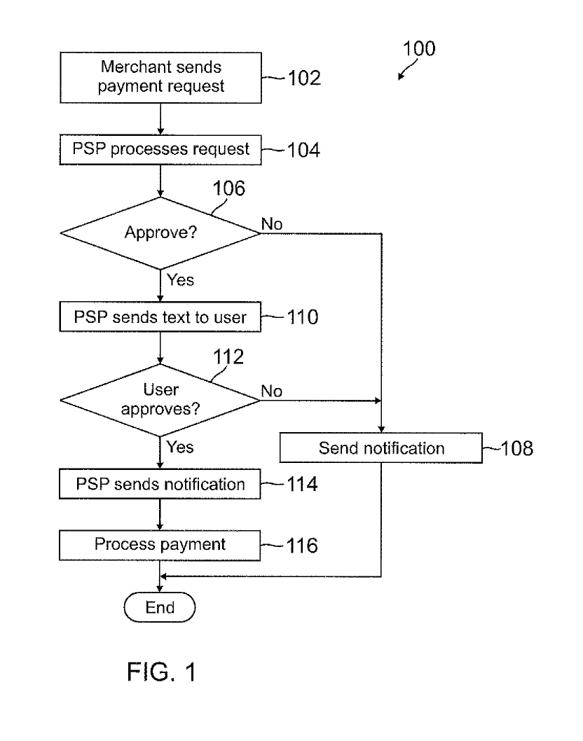

FIG. 1 is a flow chart illustrating an embodiment of a method 100 for a merchant-initiated payment process through a user device where the user receives a text message to confirm the payment. At step 102, a merchant or payee sends a payment request to a payment service provider (PSP), such as PayPal, Inc. of San Jose, Calif. The payment request may be for a user desiring to make a payment for goods and/or services (referred to generally as goods) from the merchant. In one example, the user or customer is at a point of sale (POS) ready to make a payment. The POS, in one embodiment, is a physical location of the merchant. The goods for purchase have been scanned and totaled by the merchant. Thus, the payment request send to the PSP may include details of the purchase, such as itemized goods, individual prices, any additional charges, such as tax, service charge, and shipping, and a total amount, merchant information, such as a merchant identifier, merchant name, merchant address, and/or merchant account number, and a user identifier (the user's mobile phone number in this embodiment). Other user identifiers, in different embodiments, may include a name, user name, email address, or other unique identifier. The payment request may be sent from a merchant device, such that merchant information will be automatically conveyed with the communication.

Once the payment request is received by the PSP, the request is processed at step 104 based on the information contain in the payment request. Processing may include determining whether the merchant has an account with the PSP or whether there is sufficient information about the merchant to process a payment for the merchant. If the merchant does not have an account with the PSP or there is no account information for the merchant, such as an account number and routing number for a merchant bank account, the merchant may be asked to either open an account with the PSP or provide specific account information. Processing may also include determining whether the user has an account with the PSP. The PSP may look for an account associated with the transmitted user phone number. If an account exists, the PSP may access the account for further analysis. If no account exists or the account is inactive or closed, the PSP may request the user (either through the merchant or directly with the user) to take appropriate action, such as opening an account, re-activating an old account, providing correct information, etc.

Once the user account is accessed, the PSP may determine whether to approve the payment request at step 106. This process may include determining any restrictions that are on the user account and any fraud/risk analysis. Details of the transaction may be analyzed and applied to the user's account. For example, the user account may have spending, location, and/or transaction restrictions or limits. The payment request may thus be denied for any number of reasons, such as the total amount exceeds the account limit. If the payment request is denied, as determined at step 106, the PSP may send a notification at step 108.

Notification may be sent to the merchant and/or the user. For example, the payment service provider may send a text or voice message to both the merchant and user, informing them that the payment request has been denied. The notification may include reasons, such as limit exceeded, which may allow the merchant to submit a lower amount and for the user to pay the difference in another way, such as cash, check, credit card, or debit card.

If, however, the PSP approves the payment request at step 106, the PSP sends a text message to the user's cell phone at step 110. In this embodiment, the cell phone is not a smart phone. In different embodiments, the text may be sent to other types of user communication devices and/or the message is sent by voice to the user's phone. The message includes a request for the user to confirm or cancel the payment request from the merchant. The message may also include details of the transaction, such as total amount, merchant name, etc. The user may communicate an approval or cancellation in any mariner acceptable to the PSP. For example, the user can select an appropriate button or link, select an appropriate box, press an appropriate button the user phone keypad, make an appropriate gesture on the phone touchpad, say an appropriate word or phrase into the phone, or enter a word or phrase (such as “Yes,” “No,” “Approve,” “Cancel,” etc.) as a text message, or other suitable action.

In one embodiment, the user may also be asked to enter or communicate to the PSP a PIN, code, password, or other authentication. Note that the user may be authenticated at any point, such as at the beginning of the checkout or payment process, at the end, or somewhere in between. If such an authentication is required, the user may be given a certain number of tries to enter the correct authenticator. If the user cannot be authenticated, the payment process may be canceled, with notifications being sent, such as described at step 108.

Upon receiving the user's response, the PSP determines, at step 112, whether the user approved the payment request. If the user did not approve, such as an affirmative message to cancel or decline or by not responding within a predetermined amount of time, a notification is sent, at step 108, to the user and/or merchant. The notification, as above, may be sent in various ways. However, the message may differ. For example, the user may be given a reason for the cancellation and be asked to approve if the cancellation was not intended.

If the user then approves or approved originally at step 110, the PSP sends an approved payment notification to the merchant and/or user at step 114. Again, the notification may be send in any suitable matter, including by text or voice to a merchant and/or user device. The notification may include a transaction number, receipt, or other information. The payment is processed at step 116, which may include debiting an account of the user by an appropriate amount and crediting an account of the merchant by an appropriate amount. Note that steps 114 and 116 may be performed together or in different order, as with other steps discussed with respect to the different embodiments in FIGS. 1-3.

Upon notification, the merchant and user may conclude the transaction, with the user taking delivery of the goods. As a result, the user is able to make a payment using a non-smart mobile phone.

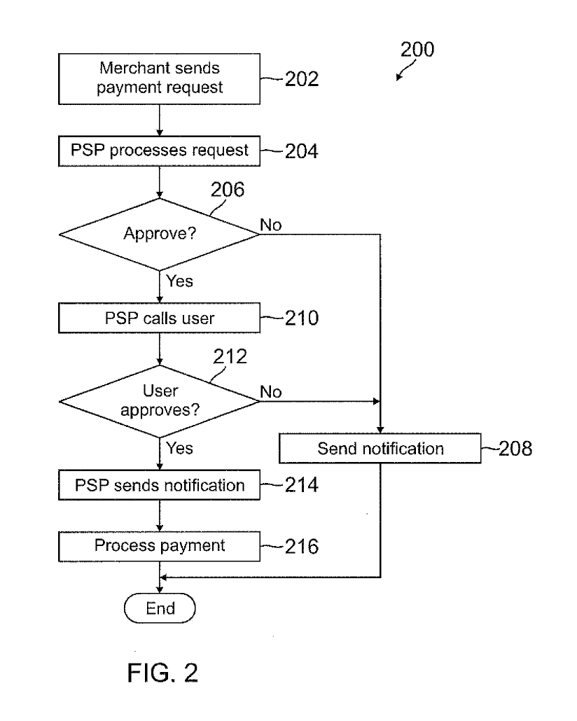

FIG. 2 is a flow chart illustrating an embodiment of a method 200 for a merchant-initiated payment process through a user device where the user receives a voice message and enters a code to confirm the payment. Steps 202, 204, 206, and 208 are the same as steps 102, 104, 106, and 108 in FIG. 1 and will not be repeated here in detail. At step 202, the merchant initiates a payment from the user by communicating a payment request to the payment service provider. The request includes details of the purchase. The PSP then processes the request at step 204 to determine whether the payment request can be approved. If not, the user and/or merchant is notified, at step 208, and the transaction is canceled or other actions taken.

If the payment request can be approved, the PSP calls the user, at step 210, with a message. The message includes a request for the user to confirm or cancel the payment request from the merchant. The message may also include details of the transaction, such as total amount, merchant name, etc. The user may communicate an approval or cancellation in any manner acceptable to the PSP. For example, the user can select an appropriate button or link, select an appropriate box, press an appropriate button the user phone keypad, make an appropriate gesture on the phone touchpad, say an appropriate word or phrase into the phone, or enter a word or phrase (such as “Yes,” “No,” “Approve,” “Cancel,” etc.) as a text message, or other suitable action. An approval may also require the user to enter or otherwise communicate a code, PIN, or other authenticator. The user may be given a certain number of attempts to communicate the correct authenticator to the PSP. If the correct authenticator is not received, the user's device and/or account may be locked, such that the user will have to go through a more rigorous process to unlock and enable payments again through the device. For example, the user may be required to call the PSP and provide certain requested information. Note that the user may be authenticated at any point, such as at the beginning of the checkout or payment process, at the end, or somewhere in between.

If the user approves, which may include the user entering the correct authenticator, the PSP sends a voice notification back to the user at step 214. Determining the correct authenticator may include the PSP accessing information from the account associated with the information obtained at step 202 and determining whether the received authenticator matches one that is stored with the PSP and associated with the account. Step 214 may also include sending a notification to the merchant, which may be by voice, text, or other means, that the payment request is approved. The payment may then be processed (or processed during or before the notification), such as crediting a merchant account and debiting a seller account with the appropriate amounts.

Thus, the user is able to make a payment with the user's phone solely by voice communication or a combination of voice and text.

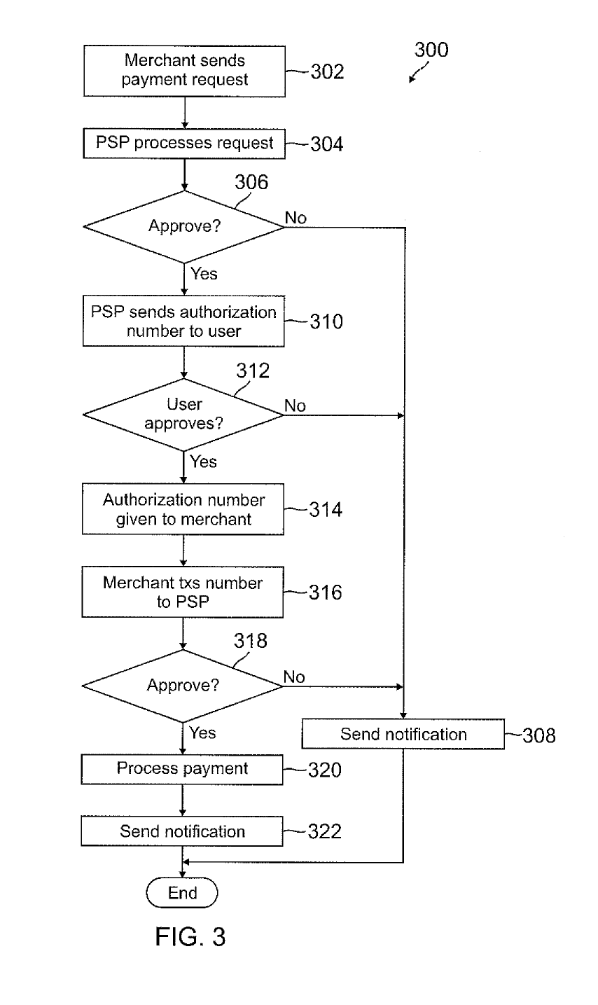

FIG. 3 is a flow chart illustrating an embodiment of a method 300 for a merchant-initiated payment process through a user device where the user receives a code to present to the merchant. Steps 302, 304, 306, and 308 are the same as steps 102, 104, 106, and 108 in FIG. 1 and will not be repeated here in detail. At step 302, the merchant initiates a payment from the user by communicating a payment request to the payment service provider. The request includes details of the purchase. The PSP then processes the request at step 304 to determine whether the payment request can be approved. If not, the user and/or merchant is notified, at step 308, and the transaction is canceled or other actions taken.

If the payment request can be approved, the PSP communicates to the user, at step 310, an authorization number or code. The communication can be by voice or text, such as SMS or email. The authorization number may be generated by the PSP and is uniquely associated with the current payment request, including restrictions or limitations of its use. For example, the authorization number may only be used within a certain time limit, by a certain merchant, and/or within a certain dollar limit. The authorization number may be a sequence of numbers, letters, characters, symbols, and/or a combination thereof. The authorization number be also be in the form of a barcode, such as a 2D barcode.

Note that like the above embodiments, the user may first need to be authenticated before the authorization number can be sent. Authorization can be my conventional means, such as entry of user credentials (user identifier, password, PIN, etc.).

The authorization number communication may include a request for the user to approve or cancel the transaction. This would allow the payment service provider to cancel the authorization number immediately so that an unauthorized user is not able to use the authorization number for a purchase. User approval or cancellation may be by the same methods described above.

If the user cancels the request or transaction, the user and/or the merchant may be notified at step 308, as discussed previously. However, if the user approves, the user communicates the authorization number, at step 314, to the merchant. This may be done in any number of ways. For example, the user may show the merchant the number displayed on the user device, the user may enter the number into a merchant device, the user may write down the number for the merchant, the user may speak the number to the merchant, the user may allow the merchant to scan a barcode or image from the user display, or the user may send the merchant a text or voice message with the number.

Next, at step 316, the merchant communicates the authorization number to the PSP, such as electronically transmitting the number from a merchant device to a PSP server. The authorization number may be transmitted in different ways, including verbally or on a keypad through a phone call. The communication may also include details of the transaction, although this is not required in some embodiments.

Upon receipt of the authorization number, the PSP determines whether the payment can be approved at step 318. The determination may include determining whether the authorization number is valid, corresponds to the proposed payment to the merchant, corresponds to the user, has not expired, is within a certain dollar amount, etc. If the payment cannot be approved, notification may be sent, at step 308, to the user and/or the merchant.

However, if the payment can be approved, the PSP processes the payment at step 320 and notifies the merchant and/or user at step 322. These steps can be combined or performed in a different order.

Thus, using the above, a user can quickly and easily make a payment through a payment provider even without having a smart phone. This allows the user to obtain the various advantages of using a payment service provider with a conventional cell phone.

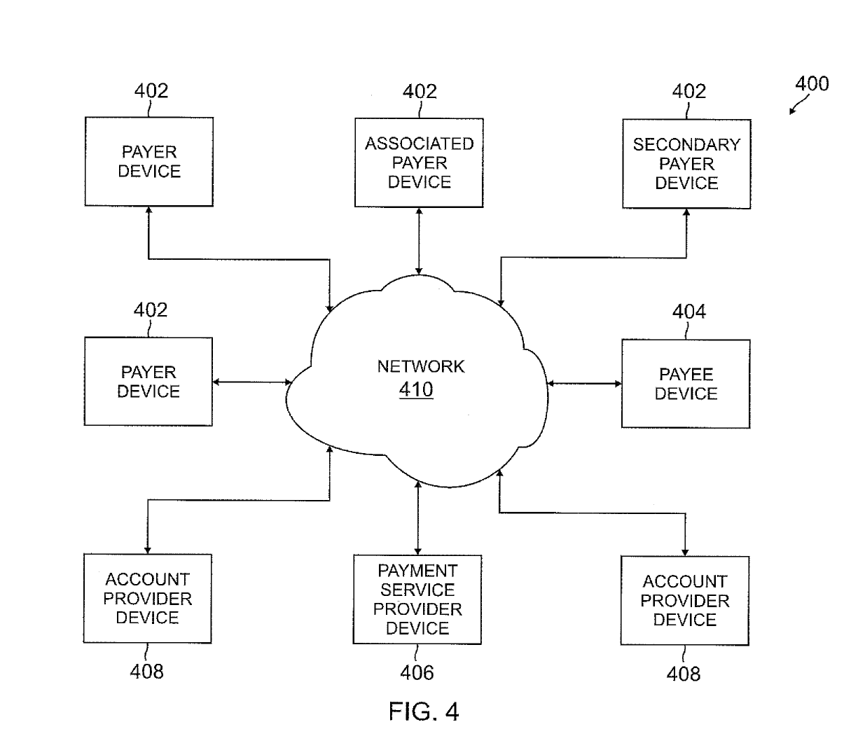

FIG. 4 shows an embodiment of a networked system 400 used in the various merchant-initiated payment transactions described above. Networked system 400 includes a plurality of payer or user devices 402, a payee or merchant device 404, a payment service provider device 406, and a plurality of account holder or funding source devices 408 in communication over a network 410. Merchant device 404 may be a payee device operated by the merchant discussed above. Payment service provider device 406 may be operated by a payment service provider such as, for example, PayPal Inc. of San Jose, Calif. Account provider devices 408 may be account provider devices operated by the account providers such as, for example, credit card account providers, bank account providers, savings account providers, and a variety of other account providers known in the art.

User devices 402, merchant device 404, payment service provider device 406, and account provider devices 408 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 400 and/or accessible over network 410.

Network 410 may be implemented as a single network or a combination of multiple networks. For example, in various embodiments, network 410 may include the Internet and/or one or more intranets, landline networks, wireless networks, and/or other appropriate types of networks.

User device 402 may be implemented using any appropriate combination of hardware and/or software configured for wired and/or wireless communication over network 410. For example, in one embodiment, user device 402 may be implemented as a personal computer of a user in communication with the Internet. In other embodiments, user device 402 may be conventional (non-smart) phone, such as a cell phone, a smart phone, personal digital assistant (PDA), laptop computer, and/or other types of computing devices.

User device 402 may include one or more browser applications which may be used, for example, to provide a convenient interface to permit the payer to browse information available over network 410. For example, in one embodiment, the browser application may be implemented as a web browser configured to view information available over the Internet.

User device 402 may also include one or more toolbar applications which may be used, for example, to provide user-side processing for performing desired tasks in response to operations selected by the payer. In one embodiment, the toolbar application may display a user interface in connection with the browser application.

User device 402 may further include other applications as may be desired in particular embodiments to provide desired features to user device 402. In particular, the other applications may include a payment application for payments assisted by a payment service provider through payment service provider device 406. The other applications may also include security applications for implementing user-side security features, programmatic user applications for interfacing with appropriate application programming interfaces (APIs) over network 410, or other types of applications. Email and/or text applications may also be included, which allow the user to send and receive emails and/or text messages through network 410. User device 402 includes one or more user and/or device identifiers which may be implemented, for example, as operating system registry entries, cookies associated with the browser application, identifiers associated with hardware of user device 402, or other appropriate identifiers, such as a phone number. In one embodiment, the user identifier may be used by payment service provider device 406 and/or account provider device 408 to associate the user with a particular account as further described herein.

Merchant device 404 may be maintained, for example, by the payee, a conventional or on-line merchant, conventional or digital goods seller, individual seller, and/or application developer offering various products and/or services in exchange for payment to be received conventionally or over network 410. In this regard, merchant device 404 may include a database identifying available event areas, pay areas, products, and/or services (e.g., collectively referred to as items) which may be made available for viewing and purchase by the payer.

Merchant device 404 also includes a checkout application which may be configured to facilitate the purchase by the user of items. The checkout application may be configured to accept payment information from the user through user device 402, the account provider through account provider device 408, and/or from the payment service provider through payment service provider device 406 over network 410.

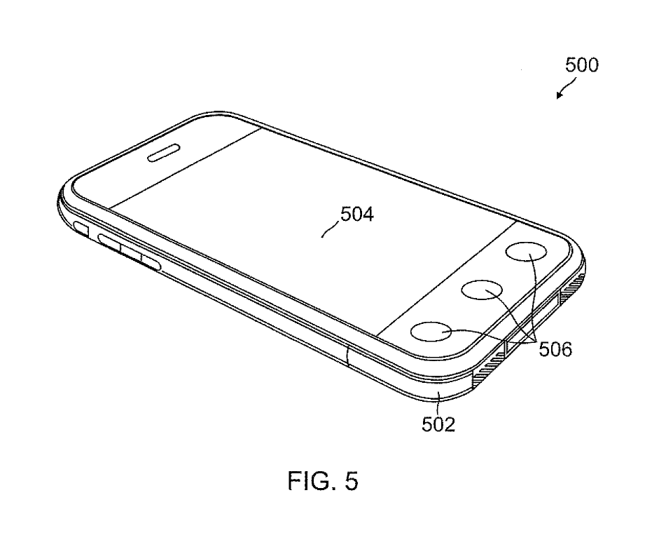

FIG. 5 shows an embodiment of a user device 500. User device 500 includes a chassis 502 having a display 504 and an input device including display 504 and a plurality of input buttons 506, such as number buttons of a keypad. One of skill in the art will recognize that user device 500 is a portable or mobile phone including a display screen and a plurality of input buttons that allow the functionality discussed above with reference to methods 100, 200, and 300. However, a variety of other portable/mobile payer devices may be used in the methods without departing from the scope of the present disclosure.

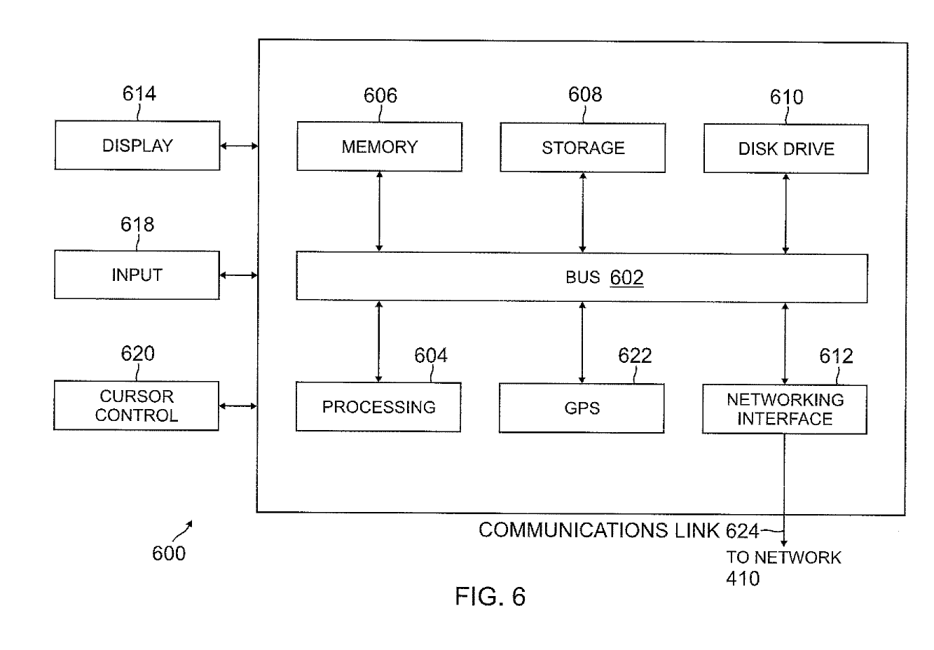

FIG. 6 shows an embodiment of a computer system 600 suitable for implementing, for example, user device 402, merchant device 404, payment service provider device 406, and/or account provider device 408. It should be appreciated that other devices utilized by users, merchants, payment service providers, and account providers in the payment system discussed above may be implemented as computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), and/or a location determination component 622 (e.g., a Global Positioning System (GPS) device as illustrated, a cell tower triangulation device, and/or a variety of other location determination devices known in the art.) In one implementation, disk drive component 610 may comprise a database having one or more disk drive components.

In accordance with embodiments of the present disclosure, computer system 600 performs specific operations by processor 604 executing one or more sequences of instructions contained in memory component 606, such as described herein with respect to the user, the merchant device(s), the payment service provider device, and/or the account provider device(s). Such instructions may be read into system memory component 606 from another computer readable medium, such as static storage component 608 or disk drive component 610. In other embodiments, hard-wired circuitry may be used in place of or in combination with software instructions to implement the present disclosure.

Logic may be encoded in a computer readable medium, which may refer to any medium that participates in providing instructions to processor 604 for execution. Such a medium may take many forms, including but not limited to, non-volatile media, volatile media, and transmission media. In one embodiment, the computer readable medium is non-transitory. In various implementations, non-volatile media includes optical or magnetic disks, such as disk drive component 610, volatile media includes dynamic memory, such as system memory component 606, and transmission media includes coaxial cables, copper wire, and fiber optics, including wires that comprise bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by computer system 600. In various other embodiments of the present disclosure, a plurality of computer systems 600 coupled by a communication link 624 to the network 810 (e.g., such as a LAN, WLAN, PTSN, and/or various other wired or wireless networks, including telecommunications, mobile, and cellular phone networks) may perform instruction sequences to practice the present disclosure in coordination with one another.

Computer system 600 may transmit and receive messages, data, information and instructions, including one or more programs (i.e., application code) through communication link 624 and network interface component 612. Network interface component 612 may include an antenna, either separate or integrated, to enable transmission and reception via communication link 624. Received program code may be executed by processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on payees and payers; however, a payer or consumer can pay, or otherwise interact with any type of recipient, including charities and individuals. The payment does not have to involve a purchase, but may be a loan, a charitable contribution, a gift, etc. Thus, payee as used herein can also include charities, individuals, and any other entity or person receiving a payment from a payer. Furthermore, the various features and steps for the different embodiments can be added to and/or substituted with features of other embodiments described herein. Having thus described embodiments of the present disclosure, persons of ordinary skill in the art will recognize that changes may be made in form and detail without departing from the scope of the present disclosure. Thus, the present disclosure is limited only by the claims.

1. A method for making a payment, comprising:
receiving, by a processor of a payment services provider, a request for payment from a merchant for a transaction with a user, wherein the request comprises merchant information, a user phone number, and transaction details comprising a total amount;
accessing an account of the user based on the user phone number;
communicating, by the processor, a request to confirm the payment to a user device through the user phone number;
receiving, by the processor, a confirmation through the user device; and
notifying, by the processor, a merchant device of a payment approval.

2. The method of claim 1, wherein the communicating is by text.

3. The method of claim 1, wherein the communicating is by voice.

4. The method of claim 1, wherein the confirmation is received by text.

5. The method of claim 1, wherein the request to confirm further comprises the total amount and a merchant identifier.

6. The method of claim 1, wherein the confirmation includes a user code.

7. The method of claim 1, further comprising authenticating the user.

8. The method of claim 7, wherein the authenticating comprises receiving a password or PIN from the user through the user device.

9. The method of claim 1, further comprising sending the user an authorization code to the user device.

10. The method of claim 9, further comprising receiving the authorization code from the merchant.

11. The method of claim 10, wherein the merchant receives the authorization code from the user.

12. A non-transitory machine-readable medium comprising a plurality of machine-readable instructions which, when executed by one or more processors, are adapted to cause the one or more processors to perform a method comprising:
receiving, by a payment services provider, a request for payment from a merchant for a transaction with a user, wherein the request comprises merchant information, a user phone number, and transaction details comprising a total amount;
accessing an account of the user based on the user phone number;
communicating, by the payment services provider, a request to confirm the payment to a user device through the user phone number;
receiving, by the payment services provider, a confirmation through the user device; and
notifying, by the payment services provider, a merchant device of a payment approval.

13. The non-transitory machine-readable medium of claim 12, wherein the communicating is by text.

14. The non-transitory machine-readable medium of claim 12, wherein the communicating is by voice.

15. The non-transitory machine-readable medium of claim 12, wherein the confirmation is received by text.

16. The non-transitory machine-readable medium of claim 12, wherein the request to confirm further comprises the total amount and a merchant identifier.

17. The non-transitory machine-readable medium of claim 12, wherein the confirmation includes a user code.

18. The non-transitory machine-readable medium of claim 12, wherein the method further comprises authenticating the user.

19. The non-transitory machine-readable medium of claim 18, wherein the authenticating comprises receiving a password or PIN from the user through the user device.

20. The non-transitory machine-readable medium of claim 12, wherein the method further comprises sending the user an authorization code to the user device.

21. The non-transitory machine-readable medium of claim 20, wherein the method further comprises receiving the authorization code from the merchant.

22. The non-transitory machine-readable medium of claim 21, wherein the merchant receives the authorization code from the user.

23. A method for making a payment, comprising:
receiving, by a processor of a payment services provider, a request for payment from a merchant for a transaction with a user, wherein the request comprises merchant information, a user phone number, and transaction details comprising a total amount;
accessing an account of the user based on the user phone number;
sending, by the processor, an authorization code to a user device through the user phone number;
receiving, by the processor, the authorization code from the merchant; and
notifying, by the processor, a merchant device of a payment approval.
